(19) United States
(12) Patent Application Publication
(10) Pub. No.: US 2010/0082832 A1
(43) Pub. Date: Apr. 1, 2010

(54) STREAM LOGGING OUTPUT VIA WEB BROWSER

(75) Inventor: Nathan George Wiger, San Diego, CA (US)

Correspondence Address: JOSHUA D. ISENBERG;JDI PATENT, 809 CORPORATE WAY, FREMONT, CA, 94539, US

(73) Assignee: Sony Computer Entertainment America Inc., Foster City, CA (US)

(21) Appl. No.: 12/243,862

(22) Filed: Oct. 1, 2008

(51) Int. Cl. G06F 15/16

(52) U.S. Cl. 709/231

(57) ABSTRACT

Methods and apparatus for transmitting stream logging data via a web browser are disclosed. A client device that implements a web browser may open a time-limited socket that remains open for a predetermined period of time. The client opens a socket to a server for bidirectional communication, which the server can transmit data across. The server sends streaming logging data to the client via the client-side socket and server side socket. Upon occurrence of an event, the server sends instructions that cause the client to keep the client-side socket open. Upon receipt of the instructions from the server the client resets a timer associated with the time-limited client side socket to keep the client-side socket open for an additional predetermined period of time.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This present invention relates to streaming content to web browsers and more specifically to streaming logging output to a browser in near-real time.

### BACKGROUND OF THE INVENTION

There is much interest in “streaming” content to web browsers currently. Many solutions use technologies that can open stateful sockets with the server natively (such as Java), or which can receive a socket from the server (such as Flash). These solutions have support limitations, since they do not work on all browsers, and are not supported natively.

It is within this context that embodiments of the present invention arise.

### SUMMARY OF THE INVENTION

According to embodiments of the invention text data may be streamed from a server to a client via a web browser. The server may receive a request to open a socket on the server from a web browser on the client. The server may open a socket in response to the request and send streaming data (e.g., text) to the client via the socket. Upon occurrence of an event, the server may send to the client code configured to cause the client to keep the socket open.

By way of example, the event that occurs may be a change in a database on the client. In such a case, the server may send code to the client to monitor the database.

### BRIEF DESCRIPTION OF THE DRAWINGS

FIG. 1 is a flow diagram illustrating the interaction between the client, browser, and server according to an embodiment of the present invention.

FIG. 2 is a block diagram illustrating a client model based on an embodiment of the present invention.

FIG. 3 is a block diagram illustrating a server model according to an embodiment of the present invention.

### DESCRIPTION OF THE SPECIFIC EMBODIMENTS

Embodiments of the present invention are directed to solving the common problem of how to provide stream logging output to a client device from a server through a web browser in near-real time. According to an embodiment of the present invention, a client may open up a socket that provides a connection to the server. The client may then continually read from the socket and write the output to a user via the browser page. Upon occurrence of an event, the server may send to the client code configured to cause the client to keep the socket open. By way of example, the event that occurs may be a change in a database on the client. In such a case, the server may send code to the client to monitor the database. In this way, log output (e.g., text output) may be provided to the client from the server as the output is being generated.

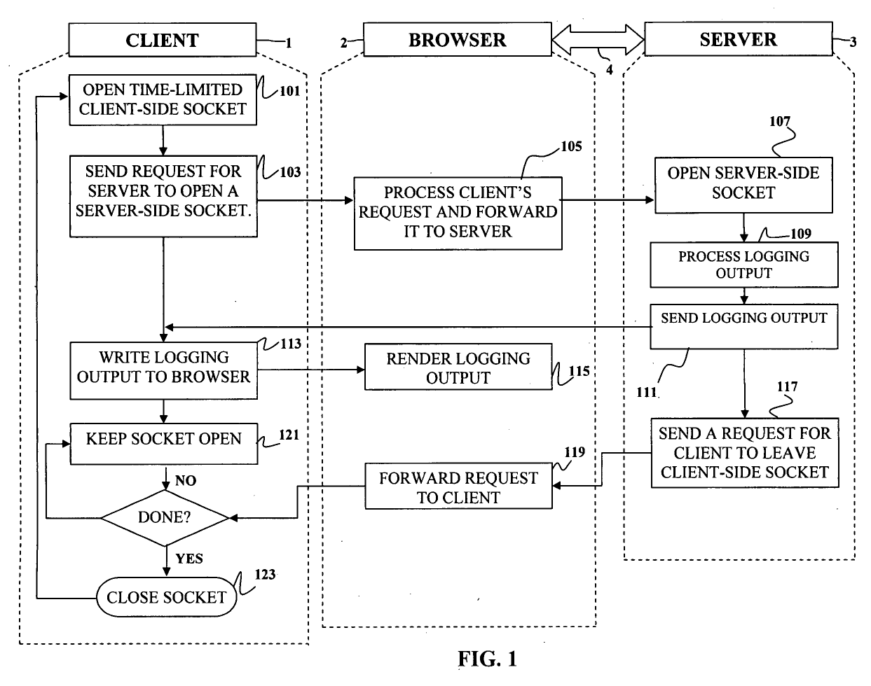

FIG. 1 is a flow diagram illustrating the interaction between the client 1, a browser 2 affiliated with the client, and a server 3 according to an embodiment of the present invention. The client 1 and server 3 may each be network-capable devices configured to communicate with other such devices via a network 4. By way of example, and not by way of limitation, the client 1 and server 3 may be any network-capable device, such as a personal computer, a video game console, cellular telephone, or portable internet device.

The browser 2 includes software and/or hardware that facilitates communication between the client 1 and other devices connected to the network 4. By way of example, the browser 2 may be a software application used to locate and display web pages. Examples of browsers include Internet Explorer from Microsoft of Redmond, Wash. and Firefox, from Mozilla Corporation of Mountain View, Calif. The browser 2 may be a graphical browser, i.e., a browser configured to display graphics as well as text. In addition, the browser 2 may be configured to present multimedia information, including sound and video. Such a browser may require plug-ins for some multimedia formats.

As indicated at 101, the client 1 initially opens up a time limited client-side socket. By way of example, and not by way of limitation, the socket may be time-limited to remain open for some relatively short predetermined period of time, e.g., approximately 2 minutes. Preferably, the predetermined period of time is long enough that the socket remains open long enough to transfer data, but not so long that the socket is open indefinitely. The client-side socket acts as an end-point for bi-directional communication flow between the client 1 and some other entity capable of communicating over the network 4. Having opened its own socket, the client now awaits responses that will be streamed by the server. By way of example, and not by way of limitation, the client 2 may use an XMLHttpRequest to compel the server to open the server-side socket. The browser 2 may process the client's request and forward the request to the server 3 as indicated at 105. After receiving the client's request, the server 3 may respond to the request by opening a server-side socket as indicated at 107. The server may then process logging output as indicated at 109. In particular, the server 3 may listen at the server-side socket for logging output to send to the client 1 via the browser 2.

Once the client 1 has opened up a socket that provides a connection to the server 3, the server may send logging output to the client via the server-side socket and client-side socket. Embodiments of the present invention may implement streaming of logging output from the server 3 to the client 1 through the use of (a) a small server component that listens for the stream logging output on a standard web port (e.g., port (80), and (b) a small amount of code in a browser that repeatedly reads the logging output so that it can be provided to the client device 1. The client 1 may then continually read the logging output from the socket and write logging output to the browser 2 as indicated at 113. The browser 2 may render the logging output in a form perceptible by a user as indicated at 115. By way of example, the client 1 may write the logging output to a well-known HTML <div> id in the browser page. In this way, log output may be provided to the user as the output is being generated.

In a specific embodiment, the browser 2 may be equipped with a small amount of code, e.g., JavaScript code, which reads from an XMLHttpRequest object resident on the client 1. The client 1 may provide stream logging output to the XMLHttpRequest object. After reading the logging output from the XMLHttpRequest object, the browser 2 may forward the output to the server 3. The XMLHttpRequest object can be an application-programming interface that allows code in the browser 2 to make requests with a server without needing to reload a web page. This allows hypertext transfer protocol (HTTP) requests to be made and responses to be received completely in the background so that a remote user can receive the output from the server 3 without experiencing any visual interruptions. The responses received from the server can be in any format that is appropriate for the specific implementation, be it XML, HTML, plain text, or other possibilities.

Because the server-side socket is time-limited, the server 3 must send an additional request to the client 1 before the time limit expires in order for the client-side socket to remain open for communication. Specifically, as indicated at 117, the server 3 may send a request to the client 1, requesting that the client 1 leave the client-side socket open. This request may be forwarded to the client by the browser 2, as indicated at 119. The client 1 may respond to the request, e.g., by leaving the socket open, as indicated at 121 The server 3 may continue to send stream logging output, as indicated at 113, to the browser 2 to be forwarded to the server 3. Alternatively, the client 1 may close the socket as indicated at 123, e.g., by allowing the socket to time out, if the server 3 has not sent a request to keep the socket open. The client 1 may subsequently open a new client-side socket, as indicated at 101 and the process may repeat.

In some embodiments, the server's request may include code that causes the client to change its behavior in response to the request. For example, if the request may include code that causes the client 1 to re-set a timer for the client-side socket, thereby leaving the client-side socket open for an additional predetermined period. In addition, the server's request may cause the client to send another request to the server 3 to open a server-side socket. This sequence of events may be repeated until the client 1 or server 3 no longer needs the socket open. Because the client-side socket is still time-limited, the server 3 must regularly make requests that the client 1 leave the client-side socket open to continue bi-directional communication.

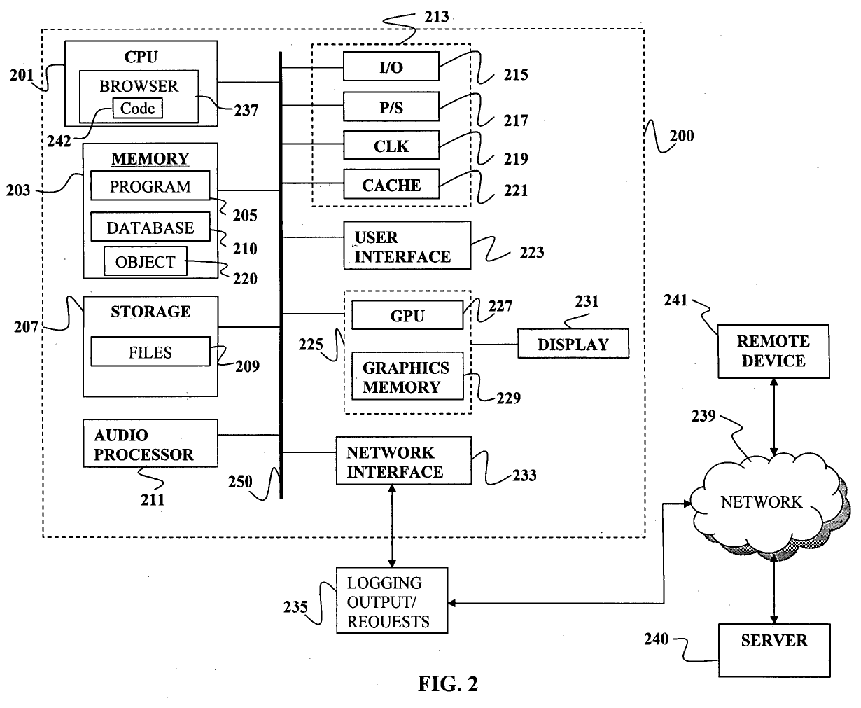

FIG. 2 is a block diagram illustrating a client model based on an embodiment of the present invention. The client model 200 may include a central processing unit (CPU) 201 and a memory 203 coupled to the CPU 201. The CPU 201 may be configured to run software applications and optionally, an operating system.

The memory 203 may store applications and data for use by the CPU 201. The memory 203 may be in the form of an integrated circuit, e.g., RAM, DRAM, ROM, and the like. A computer program 205 may be stored in the memory 203 in the form of instructions that can be executed on the processor 205. By way of example, the program 205 may include instructions that when executed by the processor causes it to implement a method for stream logging output through a browser 237 to a server 240 connected to an external network 239. The browser 237 may be implemented using the CPU 201. The ultimate destination for the logging data may be one or more remote devices 241 coupled to the network 239.

The client model 200 may also include well-known support functions 213, such as input/output (I/O) elements 215, power supplies (P/S) 217, a clock (CLK) 219, and a cache 221. The device may further include a fast data storage device 207 such as a hard disk drive that provides non-volatile storage for applications and data. The fast storage device 207 may be used for temporary of long-term storage of files 209 retrieved from a slower data device. By way of example, the storage device 207 may be a fixed disk drive, removable disk drive, flash memory device, or tape drive. Alternatively, the storage device 207 may be, e.g., a CD-ROM, DVD-ROM, Blu-Ray, HD-DVD, UMD, or other optical storage device. Files 209 from a slower storage device may be temporarily stored in a faster storage device in a hardware cache for quick loading into the memory 203.

One or more user interface devices 223 may be used to communicate user inputs from one or more users to the client model 200. By way of example, one or more of the user interface devices 223 may be coupled to the client model 200 via the I/O elements 215. Examples of suitable user interface devices 223 include keyboards, mice, joysticks, touch pads, touch screens, remote control units, light pens, still or video cameras, and/or microphones.

The client model 200 may further comprise a graphics subsystem 225, which may include a graphics processing unit (GPU) 227 and a graphics memory 229. The graphics memory 229 may be integrated in the same device as the GPU 227, connected as a separate device with the GPU 227, and/or implemented within the memory 203. The graphics subsystem 225 may periodically output pixel data for an image from the graphics memory 229 to be displayed on a video display device 231. The video display device 231 may be any device capable of displaying visual information in response to a signal from the client model 200, including CRT, LCD, plasma, and OLED displays that can display text numerals graphic symbols or images.

In addition, the video display device 231 may include one or more audio speakers that produce audible or otherwise detectable sounds. To facilitate generation of such sounds, the client model 200 may further include an audio processor 211 adapted to generate analog or digital audio output from instruction and/or data provided by the CPU 201, memory 203, and/or storage 207.

The client model 200 may further include a network interface 233. The network interface 233 is configured to initiate communication between the client and the external network 239 through the browser 237. A server 240 connected to the external network 239 can process this information and respond to the client through the browser 237, as described above with respect to FIG. 1. By way of example, and not by way of limitation, the browser 237 may be implemented as a set of instructions that are executable by the processor 201 and stored in the memory 203. The network interface 233 may be configured to open sockets to initiate bidirectional communication with a server in an external network 239, as described in FIG. 1. The network interface 233 can then stream logging output 235 to the server in the external network 239 through the browser 237. The browser 237 may use a small amount of code 242 to read from an XMLHttpRequest object 220 to process logging output 235 from the network interface 233 and forwards this to the server in the external network 239. An example of such code is shown in the COMPUTER PROGRAM LISTING at the end of the description.

Upon occurrence of an event, the server 240 may send to the client device 200 code configured to cause the web browser 239 to send a new request to the server to keep the socket open. In some embodiments, the event that occurs may occur at the client device. In such a case, the client device 200 may send a trigger signal to the server 240 that causes the server to send the code to the client device. By way of example, the event that occurs may be a change in a database 210, which may be stored in the memory 203 or as files 209 in the storage 207. The program 205 may be configured to send a trigger the server 240 upon a change in state of the database. Such a change in state may occur, e.g., when one or more data values in the database 210 have changed.

The components of the client model 200, including the CPU 201, memory 203, storage 207, audio processor 211, support functions 213, user interface 223, graphics subsystem 225, display 231, and network interface 223 may be operably connected to each other via one or more data buses 250. These components may be implemented in hardware, software, or firmware or some combination of two or more of these.

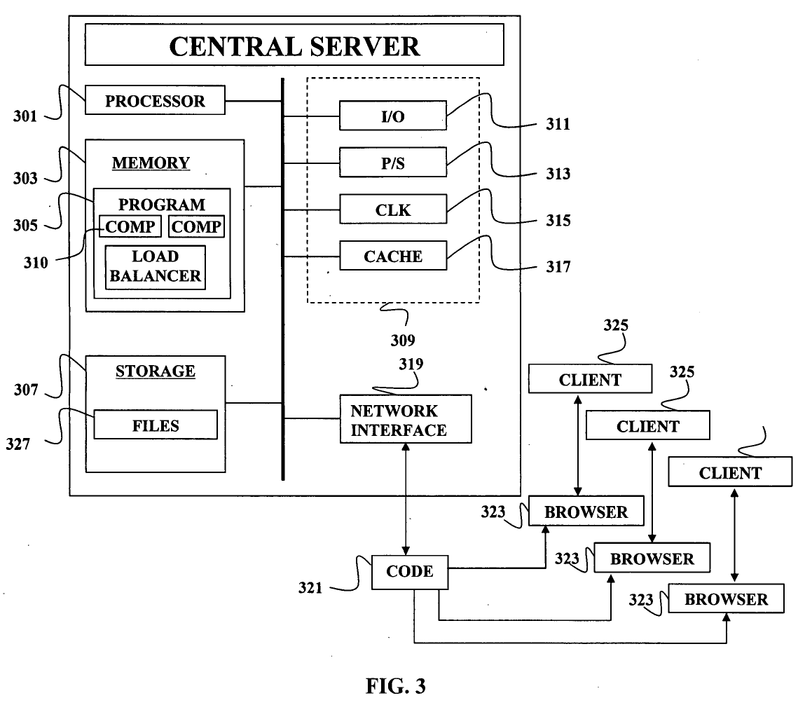

FIG. 3 is a block diagram illustrating a server according to an embodiment of the present invention. The server may include a processor 301 and a memory 303 coupled to the processor 301. The processor 301 may be configured to run certain applications in response to communication from a client 325. The processor 301 may optionally be configured to run an operating system. The processor 301 processes all information communicated to it by the other components of the server, which will be further described in detail.

The memory 303 may store applications and data for use by the processor 301. The memory 303 may be in the form of an integrated circuit, e.g., RAM, DRAM, ROM, and the like. A program 305 may be stored in the memory 303 in the form of instructions that can be executed on the processor 301. By way of example, the program 305 may include instructions that when executed by the processor 301 allows it to form bi-directional communication with the clients 325 connected to the server.

The server model 300 may also include well-known support functions 309, such as input/output (I/O) elements 311, power supplies (P/S) 313, a clock (CLK) 315, and cache 317. The server model 300 may further include a fast data storage device 307 such as a hard disk drive that provides non-volatile storage for applications and data. The fast storage device 307 may be used for temporary or long-term storage of files 327 retrieved from a slower data storage device. By way of example, the storage device 307 may be a fixed disk drive, removable disk drive, flash memory device, or tape drive. Alternatively, the storage device 307 may be, e.g., a CD-ROM, DVD-ROM, Blu-Ray, HD-DVD, UMD, or other optical storage devices. Files 327 from a slower storage device may be temporarily stored in a faster storage device in a hardware cache for quick loading into the memory 303.

The server model 300 may further comprise a network interface 319 configured to engage in bi-directional communication with clients 325 via a web browser 323. The server may be in bi-directional communication with several clients 325, each connected to their respective web browser 323. The web browser 323 is configured with a small amount of code, e.g., JavaScript code, that reads from an XMLHttpRequest object and processes requests/responses from both the client 325 and the server 300 and forwards this information to the respective clients 325 or server 300. The actual process of bi-directional communication between the client 325 and server 300 may proceed as described above with respect to FIG. 1.

In particular the program 305 may be configured by suitable programming to a) receive a request to open a socket on the server from a web browser 323 on a client 325 connected to the network 320; b) open the socket; c) receive streaming logging data from the client at the socket; and d) upon occurrence of an event, send code 321 to the client 323 that is configured to cause the web browser 323 on the client 325 to send a new request to the server to keep a client-side socket open.

The program 305 may include a small server component 310 that listens for the stream logging output from a remote client 325 on a standard web port (e.g., port (80). By way of example, the server component 310 may be implemented, e.g., as a daemon. As used herein, the term daemon refers to a computer program that runs in the background, rather than under direct control of a user. For additional reliability, multiple daemons may be run behind a load balancer 330, to support an increasing load. However, only one daemon is required for the solution to work.

Embodiments of the present invention allow streaming data to be sent from a client device to a server and other remote devices through a standard web browser with a relatively small change to the normal operation of both the client and server.

While the above is a complete description of the preferred embodiment of the present invention, it is possible to use various alternatives, modifications, and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

### Computer Program Listing:

```
//
// Part of GLUE 2, (c) 2007 Sony Computer Entertainment America
// Created by Nate Wiger <nate_wiger@playstation.sony.com>
//
// This class contains code designed to allow streaming of content.
// Essentially, it manually creates an XMLHttpRequest object so that
// we can update a div line-by-line.
//
// Must manually call so we can read *as* loading (state == 3)
Ajax.Stream = function(url, options) {
  if (!options) options = { };
  try {
  var xmlhttp = window.XMLHttpRequest ? new XMLHttpRequest( ) :
new ActiveXObject(“Microsoft.XMLHTTP”);
  xmlhttp.onreadystatechange = function( ) {
    //alert(xmlhttp.readyState + ‘\n’ + xmlhttp.responseText);
    switch (xmlhttp.readyState) {
    case 3: // loading
    if (options.onUpdate) {
      options.onUpdate(xmlhttp);
    } else if (options.update) {
      $(options.update).update(xmlhttp.responseText);
    }
    break;
    case 4: // done
    if (xmlhttp.status == 200) {
      if (options.onSuccess) options.onSuccess(xmlhttp);
    } else if (xmlhttp.status > 400) {
      if (options.onFailure) options.onFailure(xmlhttp);
    }
    if (options.onComplete) options.onComplete(xmlhttp);
    break;
    }
  }
  xmlhttp.open(“POST”, url, true);
  xmlhttp.send(options.parameters || null);
  } catch (e) {
  alert(“Ajax Error: ” + e);
  }
  return xmlhttp; // so can close
}
// This dynamically sets the height of a window.
function resizeHeight(id, offset) {
  // reset height of sidebar
  var winW, winH;
  if (parseInt(navigator.appVersion)>3) {
  if (navigator.appName==“Netscape”) {
    winW = window.innerWidth;
    winH = window.innerHeight;
  }
  if (navigator.appName.indexOf(“Microsoft”)!=−1) {
    winW = document.body.offsetWidth;
    winH = document.body.offsetHeight;
  }
  }
  // buffer from the top, since our navbar consumes space
  // allow passing in either a div id or numeric px
  var offset_px = 0;
  if (offset) {
  if (typeof offset == “number”) {
    offset_px = offset;
  } else {
    var offdiv = $(offset);
    if (offdiv) offset_px = offdiv.offsetHeight;
  }
  }
  // we have to add the text “px” to a numeric value for CSS
  $(id).height = winH − offset_px; // iframes in IE
  $(id).style.height = (winH − offset_px) + ‘px’; // CSS
}
// auto-resizes by attaching to the resize event
// see layouts/main.rhtml for an example
function autoResizeHeight(id, offset) {
  resizeHeight(id, offset);
  Event.observe(window, ‘resize’, function( ){
  resizeHeight(id, offset);
  });
}
// Automatically scrolls a div on output from the server
function autoScroll(id) {
  var elem = $(id);
  var test1 = elem.scrollHeight;
  var test2 = elem.offsetHeight;
  var scroll_height = (test1 > test2) ? test1 : test2;
  // If the scrollbar is at the very bottom already (ie, user
  // hasn't touched it), go ahead and scroll down
  // Otherwise, don't touch the scroll position
  if (elem.scrollTop >= scroll_height || elem.scrollTop == 0) {
  elem.scrollTop = scroll_height;
  }
  // the above doesn't work if Ajax callback fails...
  elem.scrollTop = scroll_height;
}
```

What is claimed is:

1. In a server connected to a network, a method for streaming logging data via a web browser on a remote client, comprising:
a) receiving a request to open a socket on the server from a web browser on a client;
b) opening server-side socket with the server;
c) sending streaming logging data to the web browser on the client via the server-side socket and a client-side socket; and
d) upon occurrence of an event, sending code from the server to the client, wherein the code is configured to cause the client to keep the client-side socket open.

2. The method of claim 1, wherein the server sends code to the client to monitor the client's database, wherein an event occurs when there is a change in the database.

3. The method of claim 2, wherein c) includes listening for the logging data at a standard web port on the server.

4. The method of claim 1 wherein the logging data is text data.

5. The method of claim 1, further comprising, before c) processing the logging output.

6. The method of claim 5, wherein processing the logging output includes forwarding the logging output to a remote device connected to the network.

7. In a client connected to a network and having a web browser, a method for streaming logging data via the web browser, comprising:
a) opening a time-limited client-side socket with the web browser, wherein the time-limited client-side socket is configured to remain open for a predetermined period of time;
b) sending a request from the client to a server connected to the network via the client-side socket, wherein the request is a request for the server to open a server-side socket;
c) receiving streaming logging data from the server-side socket with the web browser; and
d) upon receipt of one or more instructions from the server, re-setting a timer associated with the time-limited client side socket to keep the client-side socket open for an additional predetermined period of time.

8. The method of claim 7 wherein c) includes reading the logging data with the browser from an XMLHttpRequest object resident on the client.

9. The method of claim 7 wherein c) includes writing the logging data to a well-known HTML <div> id in a browser page with the browser.

10. The method of claim 7 wherein the logging data is text data.

11. The method of claim 7, further comprising sending a trigger to the server upon occurrence of the event, wherein the trigger is configured to cause the server to send the one or more instructions.

12. The method of claim 11 wherein the event is a change in a state of a database associated with the client.

13. A client device, comprising:
a processor;
a memory coupled to the processor;
a web browser executable by the processor; and
one or more instructions embodied in the memory, wherein, upon execution by the processor, the instructions cause the client device to implement a method for streaming logging data via the web browser, the method comprising:
a) opening a time-limited client-side socket with the web browser, wherein the time-limited client-side socket is configured to remain open for a predetermined period of time;
b) sending a request from the client to a server connected to the network via the client-side socket, wherein the request is a request for the server to open a server-side socket;
c) receiving streaming logging data from the server-side socket with the web browser; and
d) upon receipt of one or more instructions from the server, re-setting a timer associated with the time-limited client side socket to keep the client-side socket open for an additional predetermined period of time.

14. A server, comprising:
a processor;
a memory coupled to the processor; and
one or more instructions embodied in the memory, wherein, upon execution by the processor, the instructions cause the client device to implement a method for streaming logging data via a web browser on a remote client, the method comprising:
a) receiving a request to open a socket on the server from a web browser on a client;
b) opening the socket with the server;
c) sending streaming logging data to the web browser on the client via the server-side socket and a client-side socket; and
d) upon occurrence of an event, sending code from the server to the client, wherein the code is configured to cause the client to keep the client-side socket open.

15. The server of claim 14, wherein the instructions include a software component that listens for the stream logging output on a standard web port.

16. The server of claim 15 wherein the software component is a daemon.

17. The server of claim 16 wherein the software component includes multiple daemons that run behind a load balancer.
